(19) United States
(12) Patent Application Publication
(10) Pub. No.: US 2019/0137786 A1
(43) Pub. Date: May 9, 2019

(54) OPTHALMIC LENSES AND METHODS OF MANUFACTURING THE SAME

(71) Applicant: Mackay Medical Foundation The Presbyterian Church in Taiwan Mackay Memorial, Taipei City (TW)

(72) Inventor: Huey-chuan CHENG, TAIPEI CITY (TW)

(21) Appl. No.: 16/307,350

(22) PCT Filed: Jun. 7, 2017
(86) PCT No.: PCT/CN2017/087467

§ 371 Date: Dec. 5, 2018

Related U.S. Application Data
(60) Provisional application No. 62/346,734, filed on Jun. 7, 2016.

(51) Int. Cl. G02C 7/04

(52) U.S. Cl. CPC G02C 7/044; G02C 2202/24

(57) ABSTRACT

At least some embodiments of the present disclosure relate to an ophthalmic lens to be disposed on a cornea, the ophthalmic lens includes a first zone and a second zone. The first zone has a first vision correction power for myopia correction. The second zone is disposed radially outwardly of the first zone. The second zone surrounds the first zone. The second zone has a second vision correction power greater than the first vision correction power.

### CROSS-REFERENCE TO RELATED APPLICATIONS

This application claims the benefit of and priority to U.S. Provisional Patent Application No. 62/346,734, filed on Jun. 7, 2016, the entire contents of which are incorporated herein by reference.

### BACKGROUND

### 1. Technical Field

The present disclosure relates to ophthalmic lenses. More particularly, the present disclosure relates to ophthalmic lenses and methods of manufacturing the same.

### 2. Description of the Related Art

One of common conditions which leads to reduced visual quality is myopia. Such conditions is generally described as the imbalance between the length of the eye and the focus of the optical components of the eye. Myopic eyes focusing in front of the retina. Myopia typically develops because the axial length of the eye grows to be longer than the focal length of the optical components of the eye, that is, the eye grows too long.

A lens may be fitted to the cornea of a myopic eye to alter the gross focus of the eye to render a clearer image at the retinal plane. Paraxial light rays entering the central portion of the lens are focused on the central fovea, which is populated exclusively by cones, of the retina of the eye, producing a clear image of an object. Marginal light rays which enter the peripheral portion of the lens and pass to the cornea are focused on the peripheral retina, and produce negative spherical aberration of the image. This negative spherical aberration produces a physiological effect on the eye which tends to stimulate growth of the eye.

### SUMMARY

In accordance with some embodiments of the present disclosure, an ophthalmic lens to he disposed on a cornea, the ophthalmic lens includes a first zone and a second zone. The first zone has a first vision correction power for myopia correction. The second zone is disposed radially outwardly of the first zone. The second zone surrounds the first zone. The second zone has a second vision correction power greater than the first vision correction power.

In accordance with some embodiments of the present disclosure, an ophthalmic lens to be disposed on a cornea, the ophthalmic lens includes a first refractive surface, a second refractive surface and a third refractive surface. The second refractive surface is connected to the first refractive surface. The second refractive surface surrounds the first refractive surface. The third refractive surface is disposed opposite the first refractive surface and the second refractive surface. The first refractive surface and the third refractive surface provide a first vision correction power for myopia correction. The second refractive surface and the third refractive surface provide a second vision correction power greater than the first vision correction power.

In accordance with some embodiments of the present disclosure, an ophthalmic lens to be disposed on a cornea, the ophthalmic lens includes a positive meniscus portion and a negative meniscus portion surrounded by the positive meniscus portion.

### BRIEF DESCRIPTION OF THE DRAWINGS

FIG. 1A illustrates a top view of an ophthalmic lens according to some embodiments of the present disclosure.

FIG. 1B illustrates a negative meniscus lens according to some embodiments of the present disclosure.

FIG. 1C illustrates a positive meniscus lens according to some embodiments of the present disclosure.

FIG. 1D illustrates a cross-sectional view of an ophthalmic lens according to some embodiments of the present disclosure.

FIG. 1E illustrates a cross-sectional view and coordinates of an ophthalmic lens according to some embodiments of the present disclosure.

FIG. 1F illustrates coordinates of an aspheric surface of an ophthalmic lens according to some embodiments of the present disclosure.

FIG. 2A illustrates an operation of an ophthalmic lens according to some embodiments of the present disclosure.

FIG. 2B illustrates an operation of an ophthalmic lens according to some embodiments of the present disclosure.

FIG. 2C illustrates an operation of an ophthalmic lens according to some embodiments of the present disclosure.

### DETAILED DESCRIPTION

Common reference numerals are used throughout the drawings and the detailed description to indicate the same or similar components. Embodiments of the present disclosure will be readily understood from the following detailed description taken in conjunction with the accompanying drawings.

Spatial descriptions, such as “above,” “below,” “up,” “left,” “right,” “down,” “top,” “bottom,” “vertical,” “horizontal,” “side,” “higher,” “lower,” “upper,” “over,” “under,” and so forth, are specified with respect to a certain component or group of components, or a certain plane of a component or group of components, for the orientation of the component(s) as shown in the associated figure. It should be understood that the spatial descriptions used herein are for purposes of illustration only, and that practical implementations of the structures described herein can be spatially arranged in any orientation or manner, provided that the merits of embodiments of this disclosure are not deviated from by such arrangement.

The present disclosure describes corrective lenses used to alter the gross focus of the eye to render a clearer image at the retinal plane, by shifting the focus from in front of the plane to correct myopia.

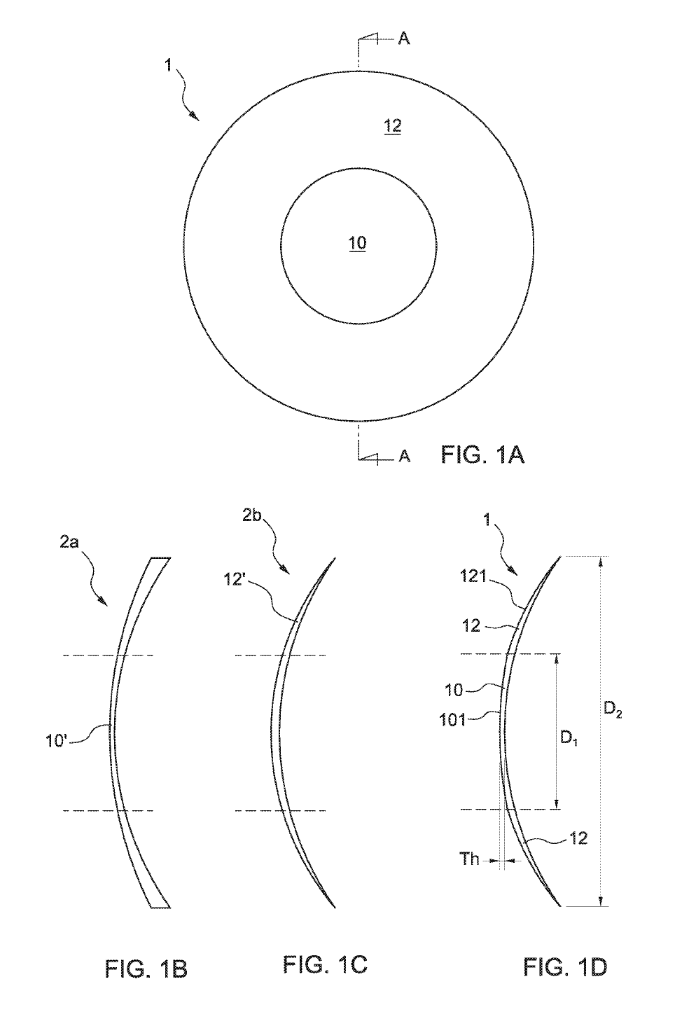

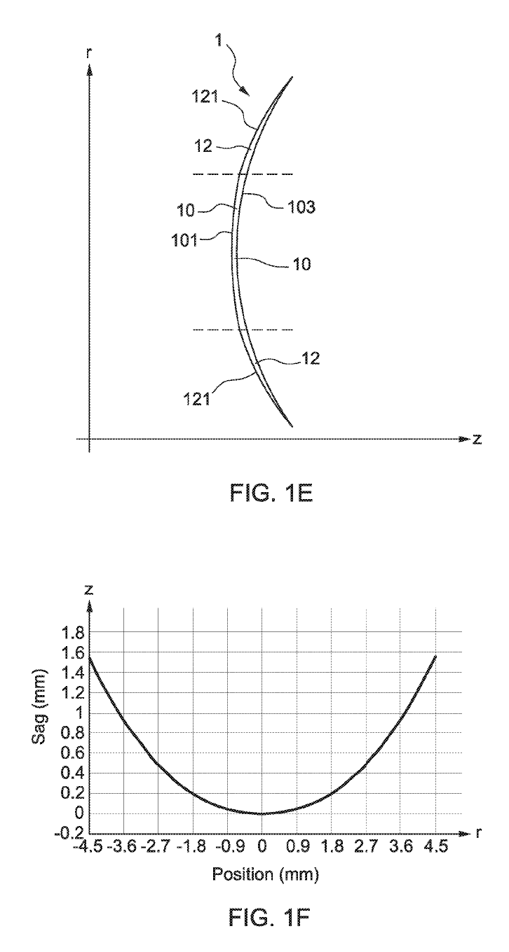

FIG. 1A illustrates a top view of an ophthalmic lens according to some embodiments of the present disclosure. Referring to FIG. 1A, an ophthalmic lens 1 includes a zone 10 and a zone 12. The ophthalmic lens 1 can be disposed or put on a cornea for myopia correction.

The zone 10 is adjacent or close to a center of the ophthalmic lens 1. The zone 10 has a vision correction power for myopia correction. The zone 10 has a vision correction power which is ranged from approximately negative 1 diopter (−1 D) to approximately negative 10 diopters (−10 D). The zone 10 may have a structure same or similar to a negative meniscus lens which is thicker at the periphery than at the centre.

The zone 12 is adjacent or close to a periphery of the ophthalmic lens 1. The zone 12 is disposed radially outwardly of the zone 10. The zone 12 surrounds the first zone 10. The zone 12 has a vision correction power greater than the vision correction power of the zone 10. The vision correction power of the zone 12 is greater than the vision correction power of the zone 10 by an optical power which is ranged from approximately positive 5 diopters (+5 D) to approximately positive 10 diopters (+10 D). The vision correction power of the zone 12 is greater than the vision correction power of the zone 10 by an optical power of approximately positive 8 diopters (+8 D). The zone 12 may have a structure same or similar to a positive meniscus lens which is thicker at the centre than at the periphery.

The zone 12 is consecutively connected to the zone 10. The zone 12 is smoothly connected to the zone 10. The zone 10 and the zone 12 are integrally formed.

FIG. 1B illustrates a negative meniscus lens according to some embodiments of the present disclosure. Referring to FIG. 1B, a negative meniscus lens 2a is thicker at the periphery than at the centre. The negative meniscus lens 2a has a relatively thin portion 10′. The central portion 10′, which is thicker at the periphery than at the centre, may have a silimar structure to the zone 10 as illustrated and described with reference to FIG. 1A.

FIG. 1C illustrates a positive meniscus lens according to some embodiments of the present disclosure. Referring to FIG. 1C, a positive meniscus lens 2b is thicker at the centre than at the periphery. The positive meniscus lens 2b has a relatively thick portion 12′. The peripheral portion 12′, which is thicker at the centre than at the periphery, may have a silimar structure to the zone 12 as illustrated and described with reference to FIG. 1A.

FIG. 1D illustrates a cross-sectional view of an ophthalmic lens according to some embodiments of the present disclosure. Reference to FIG. 1D, which illustrates a cross-sectional view of the ophthalmic lens 1 across a line AA as shown in FIG. 1A.

The ophthalmic lens 1 has a central thickness Th of approximately 0.1 mm but can be varied in other embodiments. The ophthalmic lens 1 has a refractive index of, for example, but is not limited to 1.5.

The zone 10 has a width or diameter D₁ which is ranged from approximately 0 milimeters (mm) to approximately 4 mm. The zone 10 has a refractive surface 101. The ophthalmic lens 1 has a refractive surface 103 opposite the refractive surface 101. The refractive surface 101 and the refractive surface 103 provide a vision correction power for myopia correction. The refractive surface 103 may has a radius of curvature of approximately 7.7 mm. The refractive surface 101 is an aspheric surface. The refractive surface 103 is a spheric surface.

The zone 12 has a width or diameter D₂ which is ranged from approximately 4 mm to approximately 9 mm. The zone 12 has a refractive surface 121. The refractive surface 103 is disposed opposite the refractive surface 121. The refractive surface 121 surrounds the refractive surface 101. The refractive surface 121 is connected to the refractive surface 101. The refractive surface 121 and the refractive surface 103 provide a vision correction power greater than the vision correction power provided by the refractive surface 101 and the refractive surface 103. The vision correction power provided by the refractive surface 121 and the refractive surface 103 is greater than the vision correction power provided by the refractive surface 101 and the refractive surface 103 by an optical power which is ranged from approximately positive 5 diopters (+5 D) to approximately positive 10 diopters (+10 D). The vision correction power provided by the refractive surface 121 and the refractive surface 103 is greater than the vision correction power provided by the refractive surface 101 and the refractive surface 103 by an optical power of approximately positive 8 diopters (+8 D). The vision correction power provided by the refractive surface 101 and the refractive surface 103 may range from approximately negative 1 diopter (−1 D) to approximately negative 10 diopters (−10 D). The refractive surface 121 is an aspheric surface.

A slope of a tangent varies progressively from a point (not shown in FIG. 1D) on the refractive surface 101 to another point (not shown in FIG. 1D) of the refractive surface 121. The refractive surface 101 and the refractive surface 121 are consecutive. The refractive surface 101 and the refractive surface 121 are smoothly connected.

FIG. 1E illustrates a cross-sectional view and coordinates of an ophthalmic lens according to some embodiments of the present disclosure. The refractive surface 101 of the ophthalmic lens 1 may be a Fresnel surface. The refractive surface 101 of the ophthalmic lens 1 may be determined by an aspheric high order equation. The refractive surface 101 of the ophthalmic lens 1 may be determined by an aspheric even order equation. The refractive surface 121 of the ophthalmic lens 1 may be a Fresnel surface. The refractive surface 121 of the ophthalmic lens 1 may be determined by an aspheric high order equation. The refractive surface 121 of the ophthalmic lens 1 may be determined by an aspheric even order equation. The “r” axis represents a radical coordinate. The “z” axis represents a saggital coordinate.

FIG. 1F illustrates coordinates of an aspheric surface of an ophthalmic lens according to some embodiments of the present disclosure. For example, when the zone 10 provide a vision correction power of approximately negative 3 diopters (−3 D), and the zone 10 provide a vision correction power of approximately positive 5 diopters (+5 D), the refractive surface 101 or the refractive surface 121 of the ophthalmic lens 1 may be determined by the following equation:

$$z = \frac{{cr}^{2}}{1 + \sqrt{1 - ( 1 + k ) {c}^{2} {r}^{2}}} + {a}_{1} {r}^{2} + {a}_{2} {r}^{4} + {a}_{3} {r}^{6} + {a}_{4} {r}^{8} + {a}_{5} {r}^{10} + {a}_{6} {r}^{12} + {a}_{7} {r}^{14} ,$$

where z is a sagittal coordinate, r is a radial coordinate, c is a curvature of a center of the refractive surface 101, k is a conic modulus, and each of a₁, a₂, a₃, a₄, a₅, a₆ and a₇ is an aspheric high order parameter. The curvature “c” of a center of the refractive surface 101 is approximately 0.128961276343525. The conic modulus “k” is approximately zero. The parameter “a₁” is −zero. The parameter “a₂” is −3.6477057161020400*10⁻³. The parameter “a₃” is 1.3021821798462300E*10⁻³. The parameter “a₄” is −1.72497090488718E*10⁻⁴. The parameter “a₅” is 1.1376305942429900*10⁻⁵. The parameter “a₆” is −3.7276150943708000*10⁻⁷. The parameter “a₇” is 4.8440867683785600*10⁻⁹. The positions, which include radical coordinates “r” and sagittal coordinates “z”, of the refractive surface 101 and the refractive surface 121 of the ophthalmic lens 1 is illustrated in FIG. 1F. The refractive surface 101 and the refractive surface 121 of the ophthalmic lens 1 form a smooth curve. It is contemplated that the curve showin in FIG. 1F and the parameters and the equation described above can be varied in other embodiments.

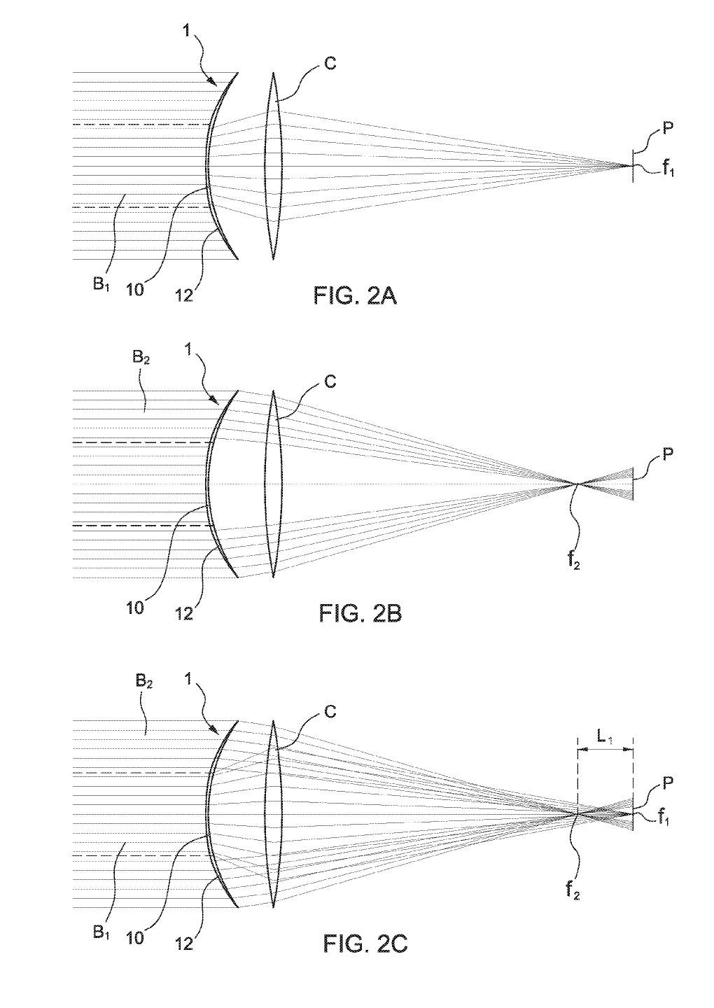

FIG. 2A illustrates an operation of an ophthalmic lens according to some embodiments of the present disclosure. Referring to FIG. 2A, the ophthalmic lens 1 is disposed on or in front of a cornea C. Paraxial light beams B₁ are refracted by the zone 10 of the ophthalmic lens 1 and the cornea to focus at a point f₁ on a retina P.

FIG. 2B illustrates an operation of an ophthalmic lens according to some embodiments of the present disclosure. Referring to FIG. 2B, the ophthalmic lens 1 is disposed on or in front of a cornea C. Marginal light beams B₂ are refracted by the zone 12 of the ophthalmic lens 1 and by the cornea to focus at a point f₂ in front of the retina P. The refracted light beams B₂ may fall out of the central fovea, which is populated exclusively by cones, of the retina P of the eye.

FIG. 2C illustrates an operation of an ophthalmic lens according to some embodiments of the present disclosure. Referring to FIG. 2B, the ophthalmic lens 1 is disposed on or in front of a cornea C. Paraxial light beams B₁ are refracted by the zone 10 of the ophthalmic lens 1 and the cornea to focus at the point f₁ on the retina P. Marginal light beams B₂ are refracted by the zone 12 of the ophthalmic lens 1 and by the cornea to focus at the point f₂ in front of the retina P. The point f₂ is separate from the point f₁ by a distance L₁. For example, when the ophthalmic lens 1 as described and illustrated with reference to FIG. 1F is disposed on or in front of a cornea C, the distance L₁ may be approximately 2.6 mm.

In some embodiments, a ophthalmic lens with an aspheric surface is provided to altering the focus of an eye to influence growth in eye length. The aspheric surface of the ophthalmic lens is designed to gradually or progressively change from the center of the lens to the periphery of the lens. The aspheric surface of the ophthalmic lens is designed to gradually or progressively change the spherical aberration of the retinal image. The aspheric surface of the ophthalmic lens, which is gradually or progressively changed from the center of the lens to the periphery of the lens, causes the eye to exhibit a positive longitudinal spherical aberration ranging from approximately +0.4 to approximately +0.8 micrometerss (μm). The aspheric surface of the ophthalmic lens, which is gradually or progressively changed from the center of the lens to the periphery of the lens, causes the eye to exhibit a positive longitudinal spherical aberration of 0.6 μm.

The aspheric surface of the ophthalmic lens, which is gradually or progressively changed from the center of the lens to the periphery of the lens, may forcus paraxial light rays on the central fovea, which is populated exclusively by cones, of the retina of the eye, to produce a clear image of an object. The aspheric surface of the ophthalmic lens, which is gradually or progressively changed from the center of the lens to the periphery of the lens, may forcus marginal light rays in front of the peripheral retina or macular, and produce posititive spherical aberration of the image. This posititive spherical aberration produces a physiological effect on the eye which tends to inhibit growth of the eye, thus mitigating the tendency for the myopic eye to grow longer.

An ophthalmic lens, comprising: an aspheric surface; and an aberration term based on a lens design in which the aberration term is positive. The aberration term may ranges from approximately +0.4 μm to approximately +0.8 μm. The aberration term may be approximately +0.6 μm.

Spherical aberration of the ophthalmic lens is altered in a positive direction to substantially halt eye length growth. Spherical aberration of the ophthalmic lens is gradually changed from the center of the lens to the periphery of the lens.

A method for preventing the progression of myopia in an eye comprising inducing a positive change in the spherical aberration of the eye by an ophthalmic lens. A method for preventing the progression of myopia in an eye comprising inducing a positive change in the spherical aberration of the eye by an aspheric surface, which is gradually or progressively changed from the center of the lens to the periphery of the lens, of an ophthalmic lens. The positive change is sufficient to alter the spherical aberration of the eye to about +0.40 μm˜+0.80 μm. The positive change is sufficient to alter the spherical aberration of the eye to about +0.60 μm.

The spherical aberration to be altered is preferably the longitudinal spherical aberration, that is, the spherical aberration of the optical system of the eye in the direction of the lens axis. For the purposes of this description, the expression “spherical aberration” is to be taken to mean longitudinal spherical aberration unless otherwise specified, “Positive spherical aberration” refers to spherical aberration resulting in a marginal focus between the paraxial focus and the lens, whereas negative spherical aberration refers to spherical aberration resulting in the marginal focus occurring on the side of the paraxial focus remote from the lens.

Spatial descriptions, such as “above,” “below,” “up,” “left,” “right,” “down,” “top,” “bottom,” “vertical,” “horizontal,” “side,” “higher,” “lower,” “upper,” “over,” “under,” and so forth, are indicated with respect to the orientation shown in the figures unless otherwise specified. It should be understood that the spatial descriptions used herein are for purposes of illustration only, and that practical implementations of the structures described herein can be spatially arranged in any orientation or manner, provided that the merits of embodiments of this disclosure are not deviated by such arrangement.

While the present disclosure has been described and illustrated with reference to specific embodiments thereof, these descriptions and illustrations are not limiting. It should be understood by those skilled in the art that various changes may be made and equivalents may be substituted without departing from the true spirit and scope of the present disclosure as defined by the appended claims. The illustrations may not necessarily be drawn to scale. There may be distinctions between the artistic renditions in the present disclosure and the actual apparatus due to manufacturing processes and tolerances. There may be other embodiments of the present disclosure which are not specifically illustrated. The specification and the drawings are to be regarded as illustrative rather than restrictive. Modifications may be made to adapt a particular situation, material, composition of matter, method, or process to the objective, spirit and scope of the present disclosure. All such modifications are intended to be within the scope of the claims appended hereto. While the methods disclosed herein have been described with reference to particular operations performed in a particular order, it will be understood that these operations may be combined, sub-divided, or re-ordered to form an equivalent method without departing from the teachings of the present disclosure. Accordingly, unless specifically indicated herein, the order and grouping of the operations are not limitations.

As used herein, the terms “substantially,” “substantial,” “approximately” and “about” are used to describe and account for small variations. When used in conjunction with an event or circumstance, the terms can encompass instances in which the event or circumstance occurs precisely as well as instances in which the event or circumstance occurs to a close approximation. For example, when used in conjunction with a numerical value, the terms can encompass a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, two numerical values can be “substantially” the same if a difference in the values is less than or equal to ±10% of an average of the values, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%.

What is claimed is:

1. An ophthalmic lens to be disposed on a cornea, comprising:
a first zone having a first vision correction power for myopia correction; and
a second zone radially outwardly of the first zone and surrounding the first zone, the second zone having a second vision correction power greater than the first vision correction power.

2. The ophthalmic lens of claim 1, wherein the second vision correction power is greater than the first vision correction power by a range from approximately positive 5 diopters to approximately positive 10 diopters.

3. The ophthalmic lens of claim 1, wherein the first zone is consecutively connected to the second zone.

4. The ophthalmic lens of claim 1, wherein the first vision correction power ranges from approximately negative 1 diopter to approximately negative 10 diopters.

5. The ophthalmic lens of claim 1, wherein the first zone has a width ranged from approximately 0 milimeters (mm) to approximately 4 mm.

6. The ophthalmic lens of claim 1, wherein the second zone has a width ranged from approximately 4 mm to approximately 9 mm.

7. An ophthalmic lens to be disposed on a cornea, comprising:
a first refractive surface;
a second refractive surface connected to the first refractive surface and surrounding the first refractive surface; and
a third refractive surface opposite the first refractive surface and the second refractive surface,
wherein the first refractive surface and the third refractive surface providing a first vision correction power for myopia correction; and
the second refractive surface and the third refractive surface providing a second vision correction power greater than the first vision correction power.

8. The ophthalmic lens of claim 7, wherein the first refractive surface is separated from the third refractive surface by a distance of approximately 0.1 mm.

9. The ophthalmic lens of claim 7, wherein the second vision correction power is greater than the first vision correction power by an optical power ranged from approximately positive 5 diopters to approximately positive 10 diopters.

10. The ophthalmic lens of claim 7, wherein the first vision correction power ranges from approximately negative 1 diopter to approximately negative 10 diopters.

11. The ophthalmic lens of claim 7, wherein a slope of a tangent varies progressively from a first point of the first refractive surface to a second point of the second refractive surface.

12. The ophthalmic lens of claim 7, wherein the first refractive surface is determined by the following equation:
$$z = \frac{{cr}^{2}}{1 + \sqrt{1 - ( 1 + k ) {c}^{2} {r}^{2}}} + {a}_{1} {r}^{2} + {a}_{2} {r}^{4} + {a}_{3} {r}^{6} + {a}_{4} {r}^{8} + {a}_{5} {r}^{10} + {a}_{6} {r}^{12} + {a}_{7} {r}^{14} ,$$
where z is a sagittal coordinate, r is a radial coordinate, c is a curvature of a center of the first refractive surface, k is a conic modulus, and each of a₁, a₂, a₃, a₄, a₅, a₆ and a₇ is an aspheric high order parameter.

13. The ophthalmic lens of claim 7, wherein the second refractive surface is determined by the following equation:
$$z = \frac{{cr}^{2}}{1 + \sqrt{1 - ( 1 + k ) {c}^{2} {r}^{2}}} + {a}_{1} {r}^{2} + {a}_{2} {r}^{4} + {a}_{3} {r}^{6} + {a}_{4} {r}^{8} + {a}_{5} {r}^{10} + {a}_{6} {r}^{12} + {a}_{7} {r}^{14} ,$$
where z is a sagittal coordinate, r is a radial coordinate, c is a curvature of a center of the first refractive surface, k is a conic modulus, and each of a₁, a₂, a₃, a₄, a₅, a₆ and a₇ is an aspheric high order parameter.

14. The ophthalmic lens of claim 7, wherein the first vision correction power is approximately negative 3 diopters.

15. The ophthalmic lens of claim 14, wherein the second vision correction power ranges from approximately positive 2 diopters to approximately positive 7 diopters.

16. The ophthalmic lens of claim 7, wherein the first refractive surface is aspheric.

17. The ophthalmic lens of claim 7, wherein the second refractive surface is aspheric.

18. The ophthalmic lens of claim 7, wherein the third refractive surface is spheric.

19. An ophthalmic lens to be disposed on a cornea, comprising:
a positive meniscus portion; and
a negative meniscus portion surrounded by the positive meniscus portion.

20. The ophthalmic lens of claim 19, whererin the positive meniscus portion is thicker at the centre than at the periphery, and the negative meniscus portion is thicker at the periphery than at the centre.
